(19) United States
(12) Patent Application Publication
(10) Pub. No.: US 2003/0034119 A1
(43) Pub. Date: Feb. 20, 2003

(54) Liquid assisted lamination of polyvinylbutyral films

(76) Inventors: Serge Molinari, Washinton, WV (US); Rick Lee Hamlet, Fayetteville, NC (US)

Correspondence Address: E I Du Pont De NeMours And Company, Legal-Patent, Wilmington, DE, 19898, US

(21) Appl. No.: 10/220,901

(22) PCT Filed: Apr. 27, 2001
(86) PCT No.: PCT/US01/13706

(51) Int. Cl. B32B 31/00

(52) U.S. Cl. 156/230; 156/247; 428/411.1

(57) ABSTRACT

The present invention is an improved process for transfer laminating a colored PVB film from a base transfer sheet onto the surface of a PVB sheet having a roughened surface. The improved process comprises wetting the contact surface of the PVB film and/or the PVB sheet prior to bringing the surfaces into contact to displace trapped air which normally interferes with complete lamination. The colored laminate composite PVB sheet can be applied to the surface of a transparent substrate to obtain a transparent laminate article having a colored band on at least part of its surface. The process results in an improved product that is more resistant to marring defects, such as scratching and high temperature pickoff, in the process of making the transparent laminate article.

This application claims the benefit of U.S. Provisional Application No. 60/200,075, filed Apr. 27, 2000.

### BACKGROUND OF THE INVENTION

1. Field of the Invention

The present invention relates to an improved process for the preparation of colored thermoplastic composite sheeting for use in laminated glass articles. This invention particularly relates to an improved process for laminating a colored thermoplastic film onto a thermoplastic sheet, which can then be used to prepare laminated glass articles that are transparent, and have increased resistance to shattering than non-laminated articles.

2. Description of the Prior Art

Laminated glass articles (also referred to herein as safety glass) having regions of color can be desirable in automobile windshields, windows for houses and buildings, showcases, and other applications where transparency and light-filtering are either required or desirable. To this end, it is known to provide a color image on a sheet of polyvinyl butyral (PVB) by coating a thin layer of colored PVB onto a thin carrier film, and subsequently transferring the colored PVB film from the carrier film onto the surface of another sheet of PVB. Such a transfer lamination process is described in U.S. Pat. No. 5,487,939 to Phillips et al.

In general, PVB films are manufactured with a rough surface to allow air to escape from laminate articles during pre-pressing, typically before exposure to an autoclave cycle. The rough surface is also necessary to help prevent the PVB surfaces from sticking to themselves when stacked or wound in rolls for transportation. While surface roughness is critical to air removal in the manufacture of safety glass, the rough surface of a PVB sheet can also contribute to incomplete lamination in other PVB lamination processes. In a colored film transfer lamination process, incomplete lamination can in turn lead to the colored coating being less resistant to marring during subsequent processing. Marring of the colored band can take the form of “scratches” when the coated article is handled at colder temperatures and pinhole type defects resembling “pickoff” when the colored band contacts high temperature surfaces.

Solvent-assisted transfer lamination of a colored PVB film onto a PVB sheet is described in Kokai Patent No. Hei 2-129,049 In this process, a PVB colored film on a base sheet is applied to a PVB sheet that has been previously covered with a solvent that dissolves the PVB, and the film and sheet are pressed together at a temperature below 40° C. The base sheet is then peeled away and the solvent is removed by volatilization. The colored image transferred to the PVB sheet according to this process is described as having excellent adhesion to the sheet. A problem with this process is that thin films can easily be dissolved by these solvents causing visual defects in the normally uniform colored coating. It is also of concern that volatile solvents can produce environmental emissions, and can involve additional process steps and process equipment to prevent worker exposure to the volatile solvents, or escape of the emissions into the environment.

De-airing can be a significant concern in most PVB lamination processes. The manufacture of laminated safety glass is typically a two step process. The first step involves a pre-press operation where the composite (PVB/glass structure before bonding) is assembled, then heated, and then pressed together either through a roller nip, a flat press or by vacuum bag or vacuum ring air removal process. The partially laminated composite normally has a significant amount of trapped air, which results in a hazy appearance. The incomplete de-airing results in numerous small air bubbles at the interface of the glass and PVB which requires the laminate article to then be-subjected to a high temperature and high pressure environment, typically an autoclave, in order to produce a clear laminate article.

Colored laminates made by conventional processes, that is a process not of the present invention, can have up to 200 pinhole defects per square centimeter when exposed to temperature above 100° C. under the conditions of the test used herein.

It is an object of the present invention to provide a process for obtaining a transparent laminate article having a color band on at least part of its surface.

It is also an object of the present invention to improve the resistance to marring of coloration on PVB sheets during the process of making colored safety glass.

It is further an object of the present invention to improve the transfer lamination of colored PVB film without using volatile solvents for PVB.

It is an object of the present invention to improve de-airing in the assembly of safety glass made with PVB interlayer by using small amounts of liquid, preferably water, to displace the air that would normally be trapped.

### SUMMARY OF THE INVENTION

In one aspect, the present invention is a process for transfer laminating a colored polyvinyl butyral (PVB) film from a base transfer sheet onto a surface of a PVB sheet, the process comprising the steps: (i) applying a liquid coat onto either (a) the surface of a PVB film (Surface A), wherein the PVB film is in contact with a base transfer sheet at the surface opposite Surface A, or (b) the surface of a PVB sheet (Surface B), or (c) both Surface A and Surface B; (ii) bringing Surface A into contact with Surface B; (iii) pressing the surfaces together at elevated temperature; and, (iv) peeling away the base transfer sheet from the PVB film to obtain a PVB laminate sheet having a colored band on at least a portion of Surface B.

In another aspect, the present invention is a PVB laminate sheet comprising a colored polyvinyl butyral film and a polyvinyl butyral sheet, wherein the laminate is obtained by a process for transfer laminating a colored polyvinyl butyral (PVB) film from a base transfer sheet onto a surface of a PVB sheet, the process comprising the steps: (i) applying a liquid coat onto either (a) the surface of a PVB film (Surface A), wherein the PVB film is in contact with a base transfer sheet at the surface opposite Surface A, or (b) the surface of a PVB sheet (Surface B), or (c) both Surface A and Surface B; (ii) bringing Surface A into contact with Surface B; (iii) pressing the surfaces together at elevated temperature; and, (iv) peeling away the base transfer sheet from the PVB film to obtain a PVB laminate sheet having a colored band on at least a portion of Surface B.

In another aspect, the present invention is a transparent laminated glass article having a colored band on at least part of its surface comprising a PVB laminate sheet which further comprises a colored polyvinyl butyral film and a polyvinyl butyral sheet, wherein the laminate is obtained by a process for transfer laminating a colored polyvinyl butyral (PVB) film from a base transfer sheet onto a surface of a PVB sheet, the process comprising the steps: (i) applying a liquid coat onto either (a) the surface of a PVB film (Surface A), wherein the PVB film is in contact with a base transfer sheet at the surface opposite Surface A, or (b) the surface of a PVB sheet (Surface B), or (c) both Surface A and Surface B; (ii) bringing Surface A into contact with Surface B; (iii) pressing the surfaces together at elevated temperature; and, (iv) peeling away the base transfer sheet from the PVB film to obtain a PVB laminate sheet having a colored band on at least a portion of Surface B; and, further laminating the PVB laminate sheet to the surface of a transparent substrate to obtain a transparent laminate article having a colored band on at least part of its surface.

In another aspect, the present invention is a glass laminating process that uses a suitable liquid, such as water, to reduce trapped air between glass and PVB in the manufacture of laminated glass articles.

### BRIEF DESCRIPTION OF THE DRAWING

FIG. 1 depicts a transfer lamination process wherein (i) a colored film on a base transfer sheet and a heated PVB sheet are fed through nip rolls and pressed together to form a colored PVB laminate that includes the base transfer sheet; and (ii) the base transfer sheet is peeled away from the colored PVB using a peel backing roll and a peel drive roll. Water can be added at any or all of three water addition points.

### DETAILED DESCRIPTION

In one embodiment, the present invention is an improved process for transfer laminating a colored PVB film (PVB film) from a colored composite film to a PVB sheet to obtain a colored PVB composite sheet (composite sheet). A composite film comprising a colored PVB film on a base transfer sheet can be obtained by known methods. For example, the base transfer sheet can first be coated with a layer of non-pigmented PVB resin and an ink layer containing finely divided crystalline pigment particles that are dispersed in a solvent-containing binder resin. In this process, both coating layers can then be dried to remove the volatile solvent, and produce a solvent-free colored composite film. For the purposes of the present invention, the PVB coat applied to the base transfer sheet is at least about 1 micron thick, but not greater than 20 microns thick. Preferably, the thickness of the PVB coat on the base transfer sheet is 4-5 microns.

The base sheet (also referred to herein as the “transfer sheet” or the “base transfer sheet”) is a sheet of material to which the colored PVB film is temporarily adhered, until such time as it is peeled away from the PVB film. The base transfer sheet can comprise any material that forms a weak adhesive bond with the PVB film, such that the transfer sheet can be peeled away without damaging the surface of the PVB film. Suitable materials for use as base sheets can be selected from the group consisting of polyester, polypropylene, polyamide, and polyvinyl fluoride. Preferred base sheet materials are selected from the group consisting of polyester and polypropylene.

The color in a PVB film can be imparted to the PVB film by either pigment or dyes. Preferably a pigment imparts the color to the film. If dyes are used, the colored film can be obtained by co-extrusion of a dye-containing resin or by direct gravure of PVB based inks onto the surface of the PVB.

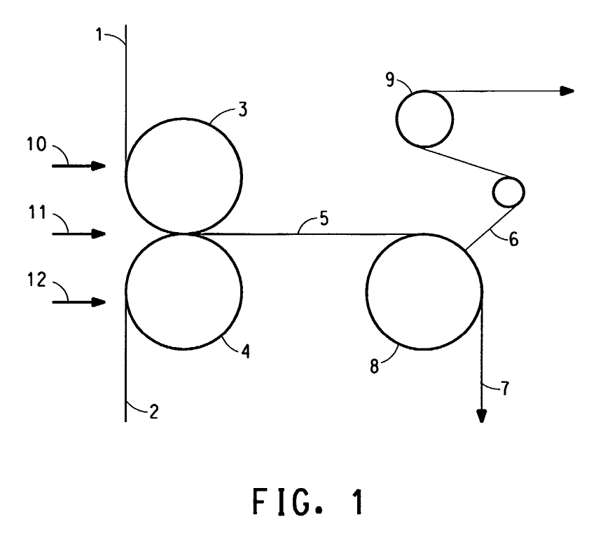

A PVB sheet useful in the practice of the present invention has a roughened surface to allow facile escape of air from the laminate during processing. PVB film can be transfer-laminated onto the roughened surface of a PVB sheet material using any conventional means of laminating thermoplastic materials. For example, the PVB film can be laminated onto the roughened surface of a PVB sheet in an autoclave, by a flat-press method or in a roller nip process. In either an autoclave or a flat press method, pieces of PVB film and PVB sheet can be laminated together by first heating the PVB and film and then subjecting the heated material to an evenly distributed pressure. The temperature at which the lamination proceeds is greater than about 40° C., and typically in the range of from about 60° C. to about 100° C. Preferably the temperature is within the range of from about 65° C. to about 85° C. The lamination typically proceeds at a pressure in the range of from about 10 psi to about 100 psi. Preferably the pressure is in the range of from about 30 psi to 60 psi. Colored PVB film can be continuously transfer laminated using a nip roller method. In a conventional nip press process, a roll of colored PVB film on a base sheet of material and a roll of PVB sheet material are brought into contact at a nip, which is a set of rollers between which the PVB materials are passed under pressure. As the materials are passed through the nip, the PVB surfaces are pressed together at elevated temperatures, such that the PVB layers adhere to each other with a force greater than the adhesive force that exists between the PVB film and the base transfer sheet. In roller nip processes, temperatures are similar to that of flat press methods. Typical nip force in a roller nip process is normally from about 1 to about 20 pounds per linear inch (pli) but preferably from 2 pli to 10 pli. A typical nip press operation is depicted in FIG. 1.

The nip rollers can either be stationary, i.e. in a fixed position, or adjustable. Typically only one roller is adjustable and the other is fixed in its position. Typically one of the rolls is driven and the other rotates freely. Both nip rollers can be driven when working with large rolls provided that some mechanism is installed that allows for slippage, such as a variable clutch. There are two types of nips, those in which only the spacing is controlled and those in which only the force is controlled. Typically, a floating nip is used which allows the spacing to vary so as to produce even nip forces around the circumference of the roll.

The thickness of the base PVB sheet is normally in the range from about 15 mils to about 60 mils. For a typical automotive application, the thickness is preferably in the range from about 30 mils to about 37 mils. The thickness of the transfer sheet can be in the range from about 0.6 mils to about 7 mils, and is preferably in the range of from about 0.6 to about 1.0 mils. The colored coating is typically very thin in order to have a minimal effect on surface roughness and caliper of the base sheeting. Coating thickness can range from about 2 microns to about 20 microns, and is preferably from about 4 microns to about 5 microns.

A lamination process of the present invention can virtually eliminate air in a composite structure, thereby requiring less pressure for complete lamination, which can improve the lamination quality and can eliminate steps in the manufacturing process. Since moisture can have a deleterious affect on adhesion between glass and PVB, the amount of moisture absorbed should be controlled either in the laminating process or by carefully controlling or minimizing the void fraction in the surface pattern of the PVB. Various methods of controlling water content would be known to one skilled in the art of glass laminate manufacturing. Other liquids can be useful in the practice of the present invention, in addition to water. Suitable liquids are not limited to pure water, and include other liquids which are not PVB solvents but are readily absorbed by PVB in small quantities can be used, for example hydrocarbons such as hexane and toluene; ethers such as ethyl ether and tetrahydrofuran; ketones such as methyl ethyl ketone and acetone; esters such as ethyl acetate; and similar compounds can be used. Preferably, water or a mixture of water with additives to enhance wetability are used. Such additives include, for example, silicone surfactants, polyols, or other compatible materials known to those skilled in the art.

In one embodiment, water is applied to at least one of the surfaces of the materials being laminated prior to pressing the surfaces together, such that at least one of the surfaces being pressed together is wet prior to contact with the other surface. When water is applied to either of the surfaces as described herein, the resulting lamination quality is improved. As such, the resulting product is much more resistant to marring by scratching and/or by pickoff. The nature of this improvement requires that only enough water be added to “flood” the nip area in order to eliminate any trapped air. Excess water, that amount above the amount that is required to eliminate trapped air, can cause incomplete coating transfer and bubble like visual defects when laminated to glass. For conventional PVB patterns produced by melt-fracture and/or embossing, the water application should be in the range of from about l micron to about 10 microns. In a particular embodiment, the amount of water required can be reduced by temporary compression of the rough surface to minimize the void area. Certain circumstances, for example at higher temperatures where evaporation of water is an issue, can necessitate that additional water be applied. Water application thickness for typical PVB patterns with maximum peak heights of 50 microns and void fractions from about 40% to about 60% are between 5 microns and 8 microns. This is typical for transfer laminating at around 65° C. to 70° C. and between 5 pli and 10 pli of nip force.

Moisture levels in commercial grade PVB's are typically controlled to within 0.4% to 0.6% moisture by weight. Numerous processing and storage factors can adversely affect moisture making the material unsuitable for normal end uses. Since moisture can be removed in heating processes, moisture removal should be balanced with moisture added according to the process of the present invention. The moisture effect of flooding the laminating nip is has been measured to be an increase in bulk sheet moisture of between 0.10% and 0.25%. More typical under controlled conditions, moisture absorption is between 0.15% and 0.20%.

In a preferred embodiment of the present invention, moisture removed by heating prior to laminating is balanced with the moisture absorbed in the laminating operation. In products requiring only partial width lamination such as shadeband applications, moisture in the non-laminated areas must also be restored. This can not be accomplished by conventional methods of exposure to a moisturizing chamber since moisture in the laminating area would also be increased. Selective moisture addition can be achieved in the non-laminated area by direct spray methods either prior to or immediately after lamination.

In another embodiment, the present invention is an improved lamination process wherein the improvement resides in the improved de-airing of the laminate article, either prior to or during the lamination process, caused by incorporation of water into the lamination process. An example of one such process is manufacture of laminated safety glass. The substitution of water or other suitable liquids that are more readily absorbed by the PVB than air can reduce the trapped air. Although excess water normally reduces glass to PVB adhesion, the PVB surface can be manufactured with very shallow roughness with a much lower void fraction allowing water assisted de-airing with a minimum of water absorption. It is also possible to manufacture the PVB polymer with very low moisture to compensate for water absorption caused by this process, and to incorporate adhesion control additive systems which are less sensitive to moisture levels in the sheeting. Under such circumstances, the glass PVB laminate article can be laminated at lower pressure and temperature, thereby minimizing the autoclaving requirements.

FIG. 1 depicts a transfer lamination process wherein (i) a colored film (1) on a base transfer sheet and a heated PVB sheet (2) are fed through nip rolls (3) and (4) and pressed together to form a colored PVB laminate that includes the base transfer sheet (5); and (ii) the base transfer sheet (6) is peeled away from the colored PVB (7) using a peel backing roll (8) and a peel drive roll (9). Water can be added at any or all of three water addition points (10), (11), and (12).

### EXAMPLES

The Examples submitted herein are for illustrative purposes only, and are not intended to limit the scope of the present invention.

### Example 1

Examples of the present invention and Comparative Examples were prepared and tested for scratch resistance.. Examples of the present invention were prepared by unwinding a roll of 30 mil PVB manufactured with a melt fractured surface with a maximum peak height of 45 microns. The PVB was heated to a temperature of 70° C. and a very thin layer of water, less than 10 microns, was coated onto one surface. The heated material was passed through a roller nip where it was contacted with a polyester film coated with a thin a layer of PVB containing an evenly distributed pigmented colorant. The two films were joined under pressure and any excess was squeezed out of the laminated article. Once the two films were thoroughly bonded together, the polyester film was peeled from the thin colored PVB layer which remained laminated to the base PVB. The PVB was then cooled and samples obtained. Comparative examples were obtained by similar methods without the presence of water in the joining process.

Scratch Test

Samples were scratched at 10° C. using a balance beam mar resistance tester with a steel rod stylus. The weight on the stylus was gradually increased until scratching was observed. The scratch results are shown in the Table 1. The results record maximum width of the scratch marks which correlate directly with the visibility of the scratches.

TABLE 1
Sample Scratch Test Results

| Stylus Force | Liquid Assisted Samples | Comparative Samples |
|---|---|---|
| (grams) | Scratch width (mm) | Scratch width (mm) |
| 100 | None | 0.2 |
| 300 | None | 0.3 |
| 500 | None | 0.5 |
| 700 | None | 0.9 |
| 900 | 0.2 | 1.2 |

### Example 2

Examples of the present invention and comparative samples were prepared consistent with the method used in Example 1. Samples were stored at 10° C. for two weeks to measure the effect of storage time on scratch resistance. Samples were subjected to scratch testing in accordance with Example 1 using additional stylus force. Results of scratch testing using this method are presented in Table 2.

TABLE 2
Delayed Sample Scratch Test Results

| Stylus Force | Liquid Assisted Samples | Comparative Samples |
|---|---|---|
| (grams) | (Scratch width mm) | (Scratch width mm) |
| 400 | None | None |
| 800 | None | 0.6 |
| 1200 | None | 0.9 |
| 1600 | None | 1.1 |
| 2000 | None | 1.1 |

### Example 3

Examples of the present invention and comparative samples were prepared consistent with the process used in Example 1. The sample materials were cooled to 10° C. and wound into roll form. The rolls were unwound and preheated by passing through a series of heated rolls before passing onto a heated drum to simulate a typical PVB stretching process. The drum temperature was varied between 95° C. and 135° C. with the colored surface of the samples in contact with the hot drum. The sheeting was pulled from the drum under higher than normal tension to exaggerate the onset of pinhole defects by causing movement between the sheeting and the drum.

Colored samples of liquid assisted and comparative samples were collected at a variety of temperatures. The samples were inspected on a light box viewer and the number of pinhole defects per square centimeter in heavily affected areas is recorded. Counts of pinhole defects under these harsh processing conditions were recorded and the ranges of pinhole defects observed are presented Table 3.

TABLE 3
Pinhole Defect Counts

| Drum | Liquid Assisted Samples |
|---|---|
| Temperature (° C.) | Pinholes/cm² |
| 95 | 0 |
| 105 | 0 |
| 115 | 0 |
| 125 | 0-10 |
| 135 | 20-50 |

### Example 4

An example of the present invention is produced by applying a colored shadeband on a portion of the sheeting using water-assisted lamination as described herein. Since the process involves bringing the sheeting to an elevated temperature, moisture loss in the sheeting is inevitable. This moisture loss can be replaced in a variety of ways but the nature of the present invention requires that a selective moisture replacement method be used. The uncolored sheeting area is sprayed with a fine mist of water using multiple nozzles across the width of the sheeting in a region of elevated sheet temperature. The number of nozzles and the nozzle flow rate are controlled based on the uncolored width and the line speed. The result of this process is a product that is manufactured with controlled and uniform levels of moisture despite the local absorption of moisture in the colored region of the sheeting where a water assisted colored layer transfer has been performed. Moisture levels in commercial grade PVB's are typically controlled to within 0.4% to 0.6% moisture by weight. This range of moisture content is easily accomplished at a variety of line speeds utilizing this method. Data obtained on moisture content of sheeting produced by this method indicates that moisture variability across the sheeting can be controlled to within 0.02% moisture content by weight.

What is claimed is:

1. A process for transfer laminating a colored polyvinyl butyral (PVB) film from a base transfer sheet onto a surface of a PVB sheet, the process comprising the steps: (i) applying a liquid coat onto either (a) the surface of a PVB film (Surface A), wherein the PVB film is in contact with a base transfer sheet at the surface opposite Surface A, or (b) the surface of a PVB sheet (Surface B), or (c) both Surface A and Surface B; (ii) bringing Surface A into contact with Surface B; (iii) pressing the surfaces together at elevated temperature; and, (iv) peeling away the base transfer sheet from the PVB film to obtain a PVB laminate sheet having a colored band on at least a portion of Surface B.

2. The process of claim 1 wherein the liquid is water.

3. The process of claim 1 wherein the temperature is greater than 40° C.

4. A colored PVB laminate sheet comprising a colored polyvinyl butyral film and a polyvinyl butyral sheet, wherein the colored laminate sheet is obtained by the process of claim 1.

5. A process for preparing a transparent laminate article having a colored band on at least part of its surface comprising the step: laminating a PVB laminate sheet of claim 4 to the surface of a transparent substrate.

6. A transparent laminate article having a colored band on at least a portion of its surface obtained by the process of claim 5.

7. A process for preparing glass/PVB laminates comprising the steps: (i) displacing air with a suitable liquid and (ii) removing the liquid either under pressure or vacuum; and (iii)heating the glass/PVB assembly such that the residual liquid is absorbed by the PVB and to obtain a clear glass/PVB laminate.

8. A process for preparing a PVB laminate comprising the steps: wetting at least one part of a PVB composite structure with water; and controlling moisture uniformity in the final product.
